(19) United States
(12) Patent Application Publication
(10) Pub. No.: US 2012/0024466 A1
(43) Pub. Date: Feb. 2, 2012

(54) WRAP FOR HAND-HELD ELECTRONIC DEVICE

(76) Inventor: Jeff Bruette, Middletown, DE (US)

(21) Appl. No.: 12/847,691

(22) Filed: Jul. 30, 2010

(51) Int. Cl. B29C 51/16; B29C 53/60

(52) U.S. Cl. 156/212; 156/391

(57) ABSTRACT

A method and apparatus to cover a perimeter of a hand-held electronic device with a wrap. The wrap provides the hand-held electronic device with a more pleasing appearance. The wrap also serves as an insulating cover over sections of the device's perimeter. Without the wrap, when the sections are gripped, signal quality in the hand-held electronic device can be reduced. The wrap also serves as a protective material on the device's perimeter reducing damage caused by foreign objects.

### BACKGROUND OF THE INVENTION

1. Field of the Invention

The present general inventive concept is directed to a method, apparatus, and computer readable storage medium directed to a wrap for a hand-held electronic device.

2. Description of the Related Art

Hand-held electronic devices, such as that illustrated in FIG. 1, are common items, yet most hand-held electronic devices are generic in appearance. What is needed is a way for owners of such devices to customize and personalize the appearance of, protect the exposed surfaces from scratches, and/or minimize radio signal interference with their devices.

### SUMMARY OF THE INVENTION

It is an aspect of the present invention to provide a wrap for a perimeter of a hand-held electronic device.

The above aspects can be obtained by an apparatus that includes (a) a wrap with an adhesive side and a non-adhesive side; (b) a transfer tape with an adhesive side and a non-adhesive side, wherein the non-adhesive side of the wrap is affixed to the adhesive side of the transfer tape; and (c) a backing affixed to the adhesive side of the wrap and the adhesive side of the transfer tape.

The above aspects can also be obtained by a method that includes (a) providing to a user: (b) a wrap with an adhesive side and a non-adhesive side; (c) a transfer tape with an adhesive side and a non-adhesive side, wherein the non-adhesive side of the wrap is affixed to the adhesive side of the transfer tape; (d) a backing affixed to the adhesive side of the wrap and the adhesive side of the transfer tape; (e) removing the backing from the transfer tape; (f) wrapping the transfer tape and affixed wrap to the perimeter of a hand-held electronic device; and (g) removing the transfer tape from the perimeter while leaving the wrap affixed to the perimeter.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a prior art drawing of a hand-held electronic device;

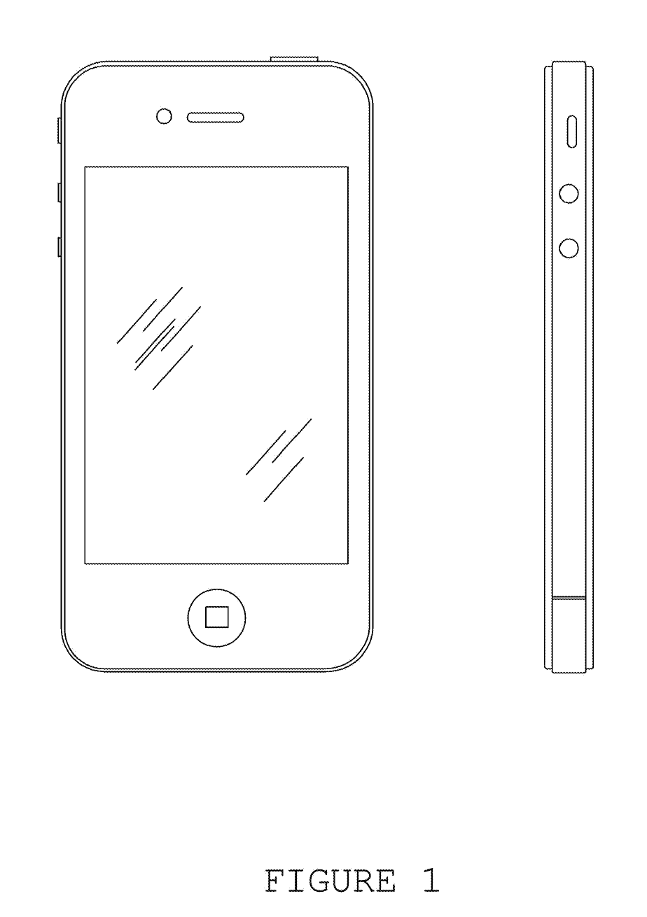

FIG. 2 is a drawing of a hand-held electronic device wrap, affixed onto a transfer tape which is affixed onto a backing, according to an embodiment;

FIG. 3 is a drawing of a hand-held electronic device wrap affixed onto a transfer tape with the backing partially peeled away, according to an embodiment;

FIG. 4 is a drawing of a hand-held electronic device wrap partially affixed to a transfer tape with the backing partially peeled away, according to an embodiment;

FIG. 5 is a drawing of a hand-held electronic device with transfer tape and wrap applied to it, according to an embodiment;

FIG. 6 is a drawing of cellular phone with a non-conductive separator between conducting parts on the perimeter, according to an embodiment, and;

FIG. 7 is a drawing of a hand-held electronic device with a conducting part on the perimeter, according to an embodiment; and

FIG. 8 is a drawing of a hand-held electronic device wrap entirely wrapped around a hand-held electronic device, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to an apparatus for personalizing a hand-held electronic device as well as for insulating parts of the device's perimeter and protecting the surface of the device's perimeter from scratches.

A wrap can be made out of plastic, PVC, paper, or other durable non-conductive material. The wrap can be sticky on one side and the non-sticky side can be affixed to a semi-sticky transparent transfer tape. The wrap is sandwiched between the transfer tape and is initially affixed to an adhesive resistant backing. The transfer tape is used to assist in applying the wrap to a perimeter of a device.

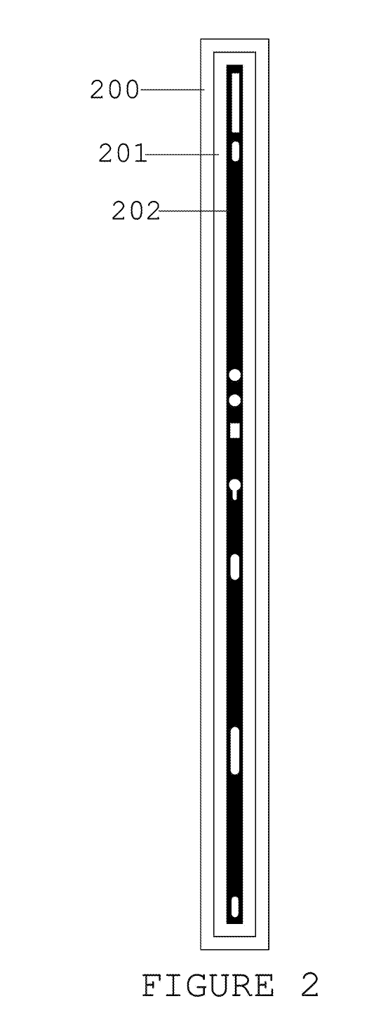

FIG. 2 is a drawing of a hand-held electronic device wrap, affixed onto a transfer tape which is affixed onto a backing, according to an embodiment.

A wrap 202 has a sticky side (like tape) and the sticky side is affixed to an adhesive resistant backing 200. The transfer tape 201 is typically translucent (like clear tape) but it is not required to be. The transfer tape 201 has an adhesive side. The adhesive side can be a standard adhesive strength (for tape) or a semi-(weak) low tack adhesive (weaker than the adhesive on the wrap itself) so that the adhesive side on the transfer tape 201 can easily peel off an object while leaving the wrap behind. The adhesive side on the transfer tape 201 is affixed to the non-sticky side of the wrap 202 and the adhesive resistant backing 200. The wrap has openings which are adapted to fit over buttons, connectors and other openings on the hand-held electronic device. Thus, wraps can come in different versions, each whish is adapted for a different model hand-held electronic devices.

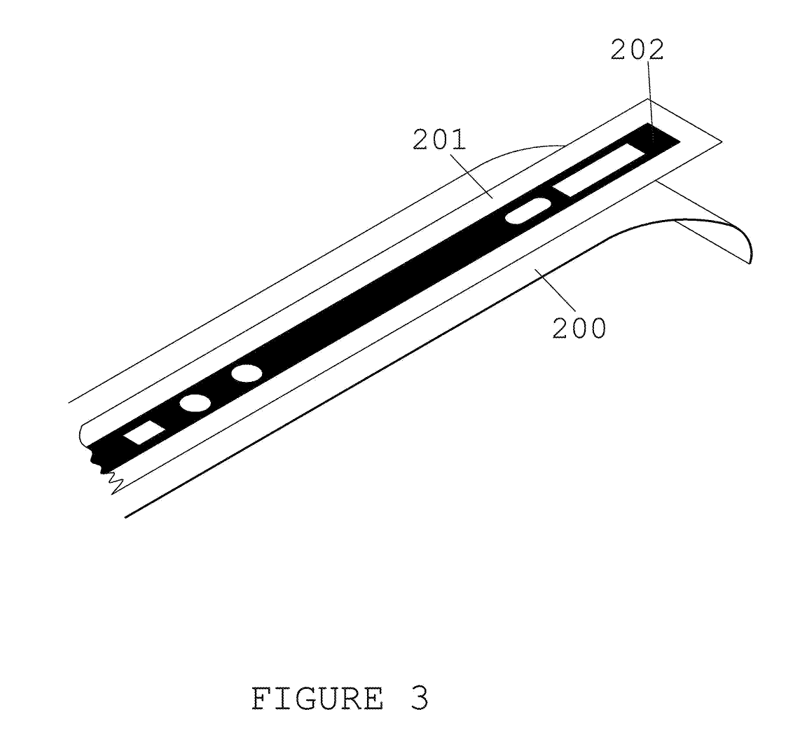

FIG. 3 is a drawing of a hand-held electronic device wrap affixed onto a transfer tape with the backing partially peeled away, according to an embodiment.

The wrap 202 is behind the transfer tape 201. The top side (non-sticky) of the wrap 202 is visible in FIG. 3, and the wrap has a bottom side (not visible in FIG. 3 because it is opposite the top side) which is sticky (has an adhesive) which contacts the perimeter of the hand-held electronic device when installed. The bottom side of the wrap 202 contacts the backing 200 (when not peeled off) while the top side of the wrap 202 contacts a bottom side of the tape 201. The tape 201 has a top side (non-sticky) opposite the tape's bottom side, the bottom side of the tape 201 also contacting the backing 200 (when not peeled off). The bottom side of the tape 201 is adhesive (sticky) in order to adhere to the top side of the wrap 202 and to remain affixed to the backing 200 while the top side of the tape 201 is typically not adhesive.

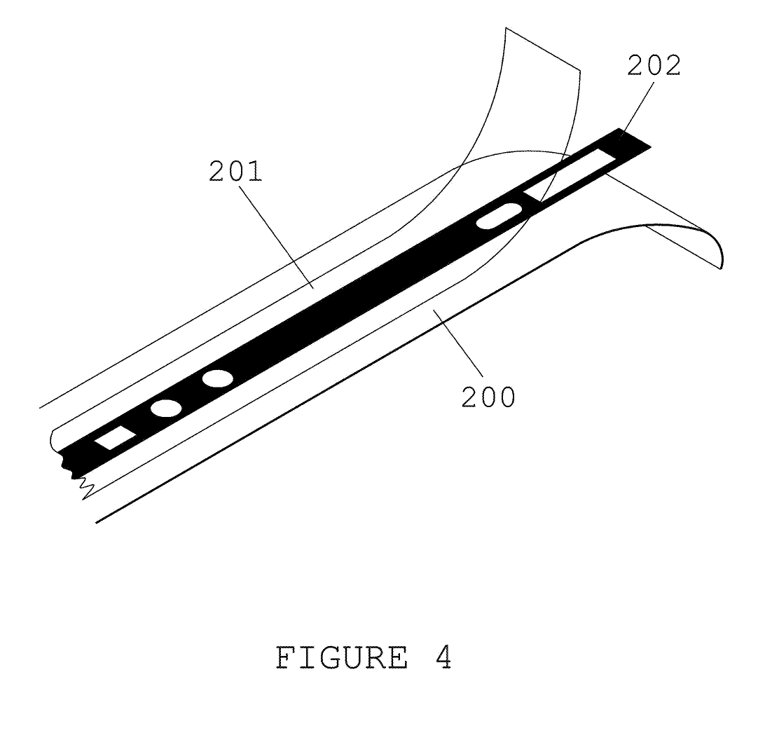

FIG. 4 is a drawing of a hand-held electronic device wrap partially affixed to a transfer tape with the backing partially peeled away, according to an embodiment.

FIG. 4 is similar to FIG. 3 but shows the transfer tape 201 peeled back from the wrap 202 thereby showing that the wrap 202 is sandwiched between the transfer tap 201 and the backing 200.

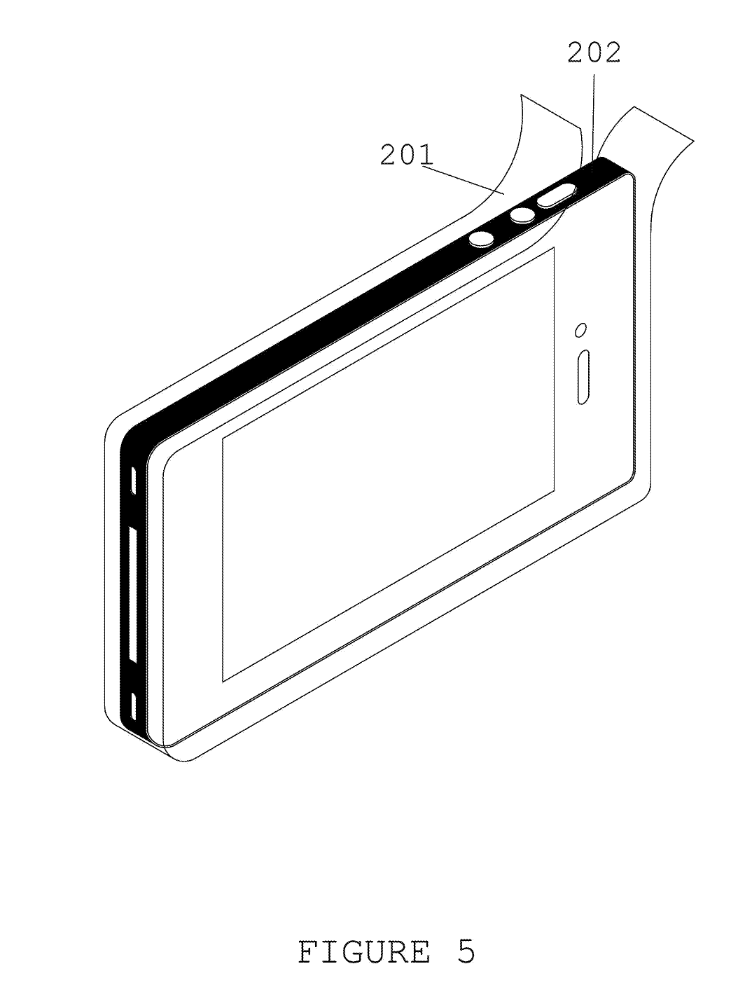

FIG. 5 is a drawing of a hand-held electronic device with transfer tape wrapped around it, according to an embodiment.

The wrap can be applied manually to a hand-held electronic device by a user. First, the user can remove the backing entirely from the transfer tape 201 and wrap 202. The user would then wrap the transfer tape 201 to the hand-held electronic device while lining up the openings in the wrap 202 with buttons on the perimeter of the device so that the buttons fit through the openings. Once the wrap 202 has been entirely affixed to the perimeter of the hand-held electronic device, the user can begin to peel the transfer tape 201 back from the wrap 202, which the adhesive (sticky side) of the wrap 202 would continue to attach to the device. Once the user has completely removed the transfer tape 201, the installation is complete.

It is noted that some hand-held electronic devices are designed with the perimeter of the device as one or more antennas. When users grip such a device and touch the antennas, they provide conductivity thereby reducing reception quality. This can be considered a design flaw of the hand-held electronic device.

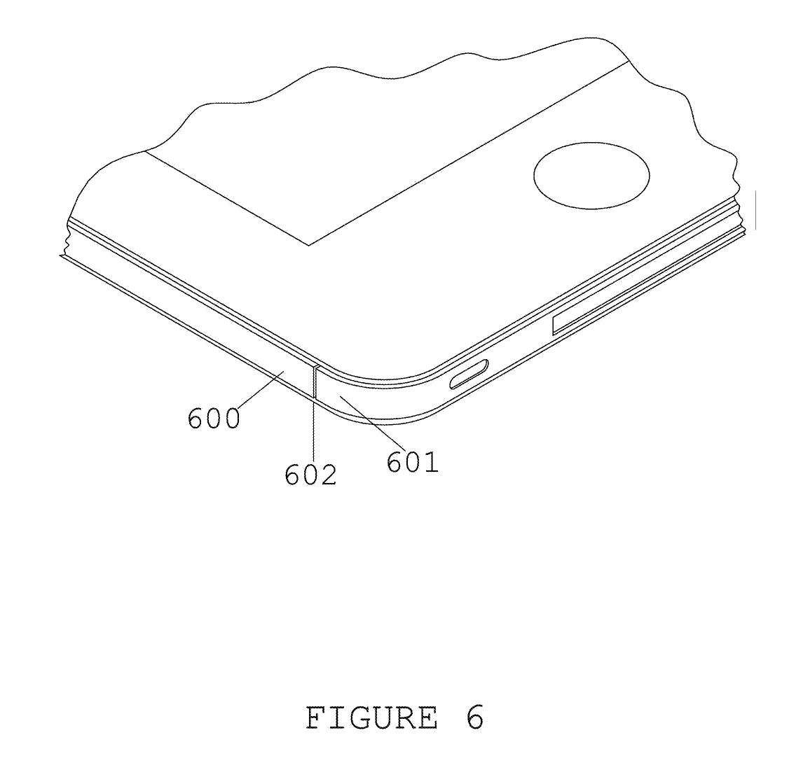

FIG. 6 is a drawing of a hand-held electronic device with a non-conductive separator between two conducting parts on the perimeter, according to an embodiment. A first antenna section 600 and a second antenna section 601 are separated by a non-conductive separator 602 which interrupts conductivity between the first antenna section 600 and the second antenna section 601.

The wrap described herein, when installed properly, can be applied to the first antenna section 600, the non-conductive separator 602, and the second antenna section 601, in order to prevent conductivity between the first antenna section 600 and the second antenna section 601. The wrap would typically be made out of a nonconductive material. Therefore, when the wrap is installed, regardless of how the perimeter of the device is gripped by the user, the first antenna section 600 would not be electronically conductive with the second antenna section 601 through the user's skin.

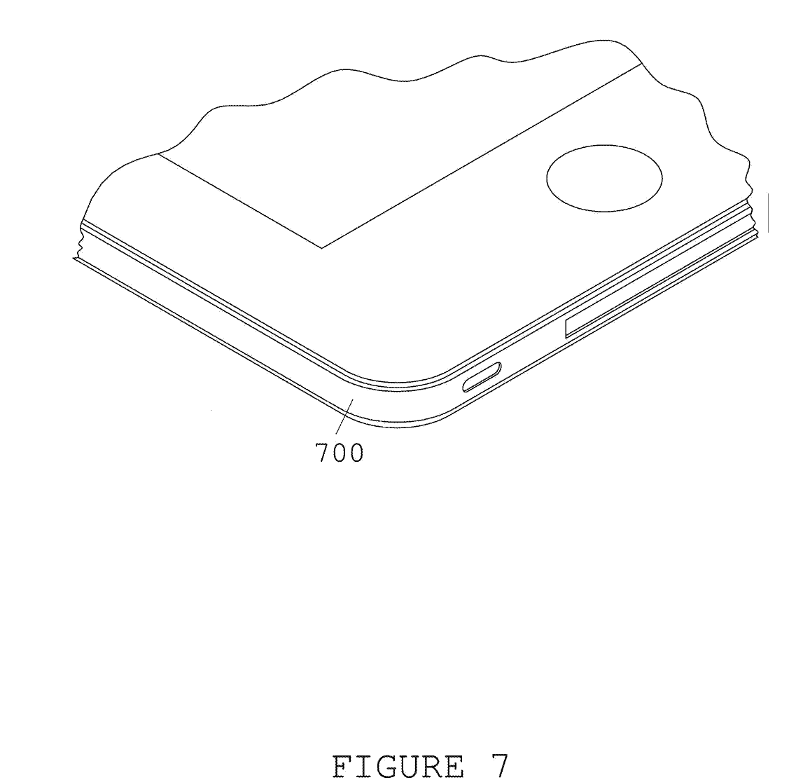

FIG. 7 is a drawing of a hand-held electronic device with a conducting part on the perimeter, according to an embodiment.

The wrap described herein, when installed properly, can be applied to the antenna section 700. The wrap would typically be made out of a nonconductive material. Therefore, when the wrap is installed, regardless of how the perimeter of the device is gripped by the user, the antenna section 700 would not be electronically conductive the user's skin.

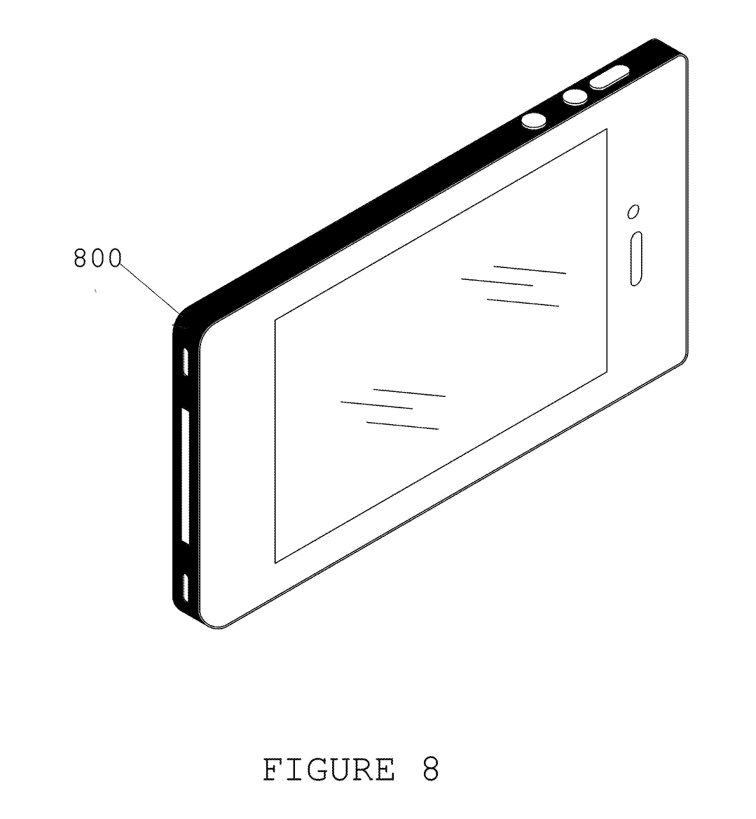

FIG. 8 is a drawing of a hand-held electronic device wrap entirely wrapped around a hand-held electronic device, according to an embodiment.

The installed wrap 800 on the hand-held electronic device provides a more pleasing appearance and protection from scratches on the hand-held electronic device. In addition, in some models of hand-held electronic devices, the wrap 800 covers the conductive perimeter (not visible in FIG. 8) thereby insulating the device's one or more antenna sections from conductivity, impedance, and attenuation created by the user's hand.

Wraps can come in different colors, including transparent, and patterns thus allowing users some discretion in personalizing their own hand-held electronic device. Wraps described herein can be used with a variety of electronic devices in addition to hand-held electronic devices, such as cellular phones, portable music players, portable digital assistants (PDAs), netbook computers, etc. Wraps can also be customized for a variety of manufacturers and devices, such as the APPLE IPHONE 4, etc.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A hand-held electronic device wrap apparatus, comprising:
a wrap with an adhesive side and a non-adhesive side;
a transfer tape with an adhesive side and a non-adhesive side, wherein the non-adhesive side of the wrap is affixed to the adhesive side of the transfer tape; and
an adhesive resistant backing affixed to the adhesive side of the wrap and the adhesive side of the transfer tape.

2. The apparatus as recited in claim 1, wherein the transfer tape is translucent.

3. The apparatus as recited in claim 1, wherein the wrap is made of non-conductive material.

4. The apparatus as recited in claim 1, wherein the wrap is made of plastic.

5. The apparatus as recited in claim 1, wherein the wrap has openings in order to accommodate buttons and device openings on a perimeter of a hand-held electronic device.

6. The apparatus as recited in claim 1, wherein the adhesive side is semi-adhesive.

7. A method to install a device wrap, the method comprising:
providing to a user:
a wrap with an adhesive side and a non-adhesive side;
a transfer tape with an adhesive side and a non-adhesive side, wherein the non-adhesive side of the wrap is affixed to the adhesive side of the transfer tape;
an adhesive resistant backing affixed to the adhesive side of the wrap and the adhesive side of the transfer tape;
removing the backing from the transfer tape;
wrapping the transfer tape and affixed wrap to the perimeter of a hand-held electronic device; and
removing the transfer tape from the perimeter while leaving the wrap affixed to the perimeter.

8. The method as recited in claim 7, wherein the hand-held electronic device has one or more antenna sections exposed in the device's perimeter and a conductor between the antenna sections or contact with an antenna section reduces signal reception quality in the hand-held electronic device.

9. The method as recited in claim 8, wherein the wrap is made of non-conductive material and serves as an insulator between the antenna sections and the user's skin.

10. The method as recited in claim 7, wherein the transfer tape is translucent.

11. The method as recited in claim 7, wherein the wrap is made of non-conductive material.

12. The method as recited in claim 7, wherein the wrap is made of plastic.

13. The method as recited in claim 7, wherein the wrap has openings in order to accommodate buttons on a perimeter of a hand-held electronic device.

14. The method as recited in claim 7, wherein the adhesive side is semi-adhesive.

15. A hand-held electronic device wrap apparatus, comprising:
a wrap with an adhesive side and a non-adhesive side;
a transfer tape with an adhesive side and a non-adhesive side, wherein the non-adhesive side of the wrap is affixed to the adhesive side of the transfer tape; and
an adhesive resistant backing affixed to the adhesive side of the wrap and the adhesive side of the transfer tape.

16. The apparatus as recited in claim 15, wherein the transfer tape is translucent.

17. The apparatus as recited in claim 15, wherein the wrap is made of plastic.

18. The apparatus as recited in claim 15, wherein the wrap has openings in order to accommodate buttons and other device openings on a perimeter of a hand-held electronic device.

19. The method as recited in claim 15, wherein the wrap serves as a protective material on the device's perimeter reducing damage caused by foreign objects.

20. The method as recited in claim 15, wherein the adhesive side is semi-adhesive.
